(19) United States
(12) Patent Application Publication
(10) Pub. No.: US 2023/0392014 A1
(43) Pub. Date: Dec. 7, 2023

(54) MODIFIED ASPHALT BINDER OR MIXTURE, AND PREPARATION METHOD THEREFOR

(71) Applicants: XI'AN ZHONGLI ASPHALT CO., LTD., Xi'an (CN); XI'AN LUCHANGTONG TRANSPORTATION TECHNOLOGY DEVELOPMENT CO., LTD, Xi'an (CN)

(72) Inventors: Yun ZENG, Xi'an (CN); Ling ZHANG, Xi'an (CN); Qiaoning ZHANG, Xi'an (CN); Xiaoli JI, Xi'an (CN); Ziyang ZHANG, Xi'an (CN); Quanwen ZHAO, Xi'an (CN); Xiaodong HAN, Xi'an (CN); Xiaohong ZHANG, Xi'an (CN)

(73) Assignees: XI'AN ZHONGLI ASPHALT CO., LTD., Xi'an (CN); XI'AN LUCHANGTONG TRANSPORTATION TECHNOLOGY DEVELOPMENT CO., LTD, Xi'an (CN)

(21) Appl. No.: 18/453,297

(22) Filed: Aug. 21, 2023

Related U.S. Application Data
(63) Continuation of application No. PCT/CN2021/077521, filed on Feb. 23, 2021.

(51) Int. Cl. C08L 95/00

(52) U.S. Cl. CPC C08L 95/00; C08L 2555/22; C08L 2555/24

(57) ABSTRACT

A modified asphalt binder according to the present application includes natural asphalt and petroleum asphalt with a weight ratio of (30-70):(70-30), wherein the ash content in the natural asphalt is up to 60% based on the natural asphalt, and the volume percentage of a trichloroethylene-insoluble-substances with particle size of more than 6 microns in the asphalt binder is less than 10%.

### CROSS-REFERENCE TO RELATED APPLICATION

This is a continuation of International Patent Application No. PCT/CN2021/077521 filed on Feb. 23, 2021. The disclosure of the above-referenced application is hereby incorporated by reference in its entirety

### BACKGROUND

Guss-asphalt mixture and high-modulus asphalt mixture are two types of asphalt mixtures respectively for special purposes. The high-modulus asphalt mixture is characterized by high modulus, strong carrying capacity and long fatigue life, so it is suitable for paving long-life asphalt pavement and heavy-loaded traffic pavement. The guss-asphalt mixture has characteristics of self-compaction and no need to be rolled, so it is widely used in bridge pavement and other projects. Both the two types of asphalt mixtures need hard asphalt with small penetration degree as the binders.

The hard penetration grade asphalt is directly used as a binder in the high-modulus asphalt mixtures overseas. However, due to oil source properties, processing technology and other issues, it is difficult for oil refining enterprises in China to produce a hard penetration grade asphalt that can be used to prepare the high-modulus asphalt directly. Yu Jia, chief engineer of Jiangsu Transportation Research Institute, emphasized that hard penetration grade asphalts in China (such as asphalt 10 #, asphalt 20 # or asphalt 30 #) are not the same as hard penetration grade asphalts overseas. Therefore, the domestic hard penetration grade asphalts in China cannot be directly applied in the guss-asphalt mixture and the high-modulus asphalt mixture. The domestic hard penetration grade asphalts need to be modified to obtain required properties.

### SUMMARY

The disclosure relates to the field of pavement materials, in particular to a modified asphalt binder and mixture, and a preparation method therefor.

The purpose of the disclosure is to provide a lower cost and simpler modified asphalt binder and a preparation method thereof, and to apply the same to an asphalt mixture.

The first aspect of the disclosure provides a modified asphalt binder, including a natural asphalt and a petroleum asphalt with a weight ratio of (30-70):(70-30). An ash content in the natural asphalt is up to 60% based on a weight of the natural asphalt, and a volume percentage of trichloroethylene-insoluble-substances with a particle size of 6 microns or more in the modified asphalt binder is less than 10%.

The second aspect of the disclosure provides an asphalt mixture with the modified asphalt as a binder. The asphalt mixture includes the asphalt binder of the first aspect of the disclosure and aggregate.

The third aspect of the disclosure provides a preparation method for the modified asphalt binder of the first aspect of the disclosure. The method includes the following operations.

A natural asphalt is crushed to 300-1000 mesh and the natural asphalt is added to a molten petroleum asphalt to form an asphalt blend.

The asphalt blend is ground when a temperature of the asphalt blend raises to 160° C.-180° C. to obtain the modified asphalt binder.

### BRIEF DESCRIPTION OF THE DRAWINGS

FIG. 1 shows a particle size distribution diagram of trichloroethylene-insoluble-substances in the binder prepared in Example 1.

FIG. 2 shows a particle size distribution diagram of trichloroethylene-insoluble-substances in the binder prepared in Example 2.

FIG. 3 shows a particle size distribution diagram of trichloroethylene-insoluble-substances in the binder prepared in Example 3.

FIG. 4 shows a particle size distribution diagram of trichloroethylene-insoluble-substances in the binder prepared in Comparative Example 1.

### DETAILED DESCRIPTION

As used herein, the terms “comprise/include” “contain” or any other variation thereof are intended to cover non-exclusive inclusion, so that a method or a composition including a series of elements includes not only the explicitly stated elements, but also other elements not explicitly listed, or elements inherent to the implementation of the method or the composition. In the absence of further limitations, an element defined by the phrase “include a/an . . . ” does not exclude the existence of other related elements in the method or composition including the element.

As used herein, the term “consist/be composed of” means that the method or the composition contains only the stated elements, i.e. it contains no other elements except the stated elements.

The elements are, for example, operations of the method, or components of the composition, or the like.

An asphalt content in the guss-asphalt mixture is up to 8-12%, which is 2-3 times that of a conventional asphalt mixture, to ensure construction workability of the guss-asphalt mixture. However, it is necessary to ensure high temperature stability of the mixture with such a large asphalt-aggregate ratio. Therefore, the hard penetration grade asphalt is also suitable for the guss-asphalt mixture. In addition, the guss-asphalt mixture must be stirred at 220° C.-250° C. for 40 min-240 min before use to obtain better properties, so the guss-asphalt binder must have good high-temperature aging resistance.

There are usually two types of asphalt binders applied in the guss-asphalt mixture. One type of them is obtained by adding a large number of elastomeric polymer (such as SBS, etc., whose addition amount reaches 7-9%) to modify the petroleum asphalt. However, the type of asphalt binder not only has high cost, but also has a risk of polymer degradation at a high temperature, which affects its service life. In addition, due to the existence of macromolecular polymer modifier, the mechanisms of its aging and regeneration are inconsistent with asphalt, so the aged asphalt pavement mixture cannot be recycled.

The other type is the petroleum asphalt obtained by adding a lake asphalt which has a high asphalt content among natural asphalts by a wet process. However, the wet process is required to add the lake asphalt to the petroleum asphalt on site, which leads to complicated construction, unstable in quality and difficult to store. Moreover, rock asphalts with lower cost cannot be applied in the wet process.

The applicant disclosed a finished binder for a guss-asphalt mixture and a preparation method thereof in Chinese patent application No.: CN107739521A, in which chlorinated polyethylene rubber and thermoplastic elastomer modifier (SBS) were swelled with a petroleum asphalt before adding a natural asphalt mother liquor whose minerals had been ground to less than 5 microns, so that insoluble particles in the natural asphalt enter a network structure formed by the rubber and the modifier, thus improving the performance of the guss-asphalt binder.

For the asphalt binder applied in the high-modulus asphalt mixture, the Chinese patent application No.: CN107118578A of the applicant discloses that, an asphalt mother liquor containing natural asphalt and petroleum asphalt was ground to make the average particle size of trichloroethylene-insoluble substances in a range of 5000-10000 mesh, and then the coupling agent, macromolecular polymer modifier and crosslinking agent were further added to obtain a high-modulus asphalt binder modified by the natural asphalt.

The above methods partially solve the influence of insoluble minerals in the natural asphalt on the stability of the asphalt mixture, so that the natural asphalt can be stored for a long time, rather than prepared on a construction site when it is in need. However, in order to stabilize the mineral particles in the natural asphalt, polymer modifier or coupling agent and crosslinking agent are still needed in the above-mentioned methods in which the natural asphalt is used. Therefore, there are still problems such as high-temperature degradation and easy aging.

In view of the above, the disclosure provides a modified asphalt binder, including a natural asphalt and a petroleum asphalt with a weight ratio of (30-70):(70-30). An ash content in the natural asphalt is up to 60% based on a weight of the natural asphalt, and a volume percentage of trichloroethylene-insoluble-substances with a particle size of 6 microns or more in the modified asphalt binder is less than 10%.

According to an embodiment, the asphalt binder of the disclosure includes the natural asphalt and the petroleum asphalt with a weight ratio of (35-60):(65-40), preferably (40-55):(60-45).

According to an embodiment, the ash content in the natural asphalt is up to 50% based on the weight of the natural asphalt, and the volume percentage of the trichloroethylene-insoluble-substances with particle size of 6 microns or more in the modified asphalt binder is less than 5%.

The type of the natural asphalt in the disclosure is not limited and may be selected from at least one of rock asphalt or lake asphalt. According to the method of the disclosure, the natural asphalt with the ash content up to 60 wt %, preferably up to 50 wt %, may be used. Therefore, at present, natural asphalt from most origins may be used in the disclosure.

The ash content of a natural asphalt indirectly indicates effective asphalt content in the natural asphalt. When the natural asphalt has high ash content, processing is difficult, it has high risk of precipitation and segregation, but its price is low. For example, the natural asphalt that may be used in the disclosure includes Iranian rock asphalt, Buton rock asphalt, Trinidad lake asphalt, or China Qingchuan rock asphalt, etc., but is not limited thereto. Iranian rock asphalt usually has an ash content of 10%-30%. Buton rock asphalt usually has an ash content of about 45%-50%. Trinidad lake asphalt usually has an ash content of about 30%, but its price is 5-7 times that of Buton rock asphalt. Therefore, the method of the disclosure can also reduce the cost to a certain extent.

According to an embodiment of the disclosure, two or more natural asphalts may be used in combination to obtain suitable properties. The cost is also low.

When the ash content of the natural asphalt is within the range of the disclosure, good properties can be obtained, and all of the properties meet relevant standards. High ash content can also improve the high-temperature stability of the mixture, but will affect storage stability of the asphalt binder and make the asphalt binder more difficult to process.

According to the preparation method for the modified asphalt binder in the disclosure, which will be described in detail below, a particle size distribution of the trichloroethylene-insoluble-substances in the binder of the disclosure differs from a normal distribution obtained by grinding from conventional methods. The volume percentage of the particles with larger sizes decreases sharply, showing a negatively skewed distribution. The volume percentage of the particles with the particle size of 6 microns or more is less than 10%, preferably less than 5%.

It is known that particles with larger particle sizes are easier to settle. With a progress of grinding, the insoluble particles size decreases continuously, and the viscosity of the asphalt further increases, which makes it difficult to further reduce the particle sizes. Especially for the rock asphalt with high ash content but low price, it is more difficult to obtain the asphalt with the above size distribution.

According to the method of the disclosure described in detail below, the natural asphalt and total amount of the petroleum asphalt in the final binder are directly ground together at an elevated temperature, so that the volume percentage of the obtained trichloroethylene-insoluble-substances with particle size of 6 microns or more is less than 10%, or even less than 5%. Therefore, the influence of the trichloroethylene-insoluble-substances in the obtained asphalt binder on the stability of the binder is greatly reduced, and thus the obtained asphalt binder can be kept in a stable state for a long time without segregation in the absence of additional additives for stabilizing particles.

The petroleum asphalt that may be used in the disclosure is not particularly limited, and an appropriate brand may be selected as needed. For example, one or more of road petroleum asphalt 50 #, road petroleum asphalt 70 #, road petroleum asphalt 90 # or road petroleum asphalt 110 # may be selected, but is not limited thereto.

A range of the penetration degree of the asphalt binder in the disclosure is 10-25 dmm, a softening point is not lower than 60° C., and the storage stability requires that the softening point difference after 48 h segregation is not higher than 2.5° C.

The penetration degree of the modified asphalt binder in the disclosure is 10-25 dmm, thus meeting the technical requirements of the guss-asphalt mixture and the high-modulus asphalt mixture.

According to a preferred embodiment, the trichloroethylene-insoluble-substances in the modified asphalt binder of the disclosure have an average particle size of 2-6 μm, preferably 3-4 μm.

According to a specific embodiment of the disclosure, the modified asphalt binder consists only of the natural asphalt and the petroleum asphalt.

The modified asphalt binder of the disclosure without adding any additives for stabilizing particles can achieve good properties, meets the relevant requirements, simplifies the components and reduces the cost. In addition, if only the natural asphalt and the petroleum asphalt are used to form the binder, they can be recycled because of their consistent aging and regeneration mechanism, which is beneficial to saving energy. However, a conventional asphalt binder with macromolecular polymer is difficult to be recycled because of the irreversible aging of the macromolecular polymer. Therefore, the binder of the disclosure preferably does not contain any macromolecular polymer.

In addition, the application of additives is avoided in the composition of the modified asphalt binder of the disclosure, which is helpful to improve weathering resistance of asphalt roads and avoids pollution of the additives in the asphalt roads to soil and water resources.

The disclosure further provides an asphalt mixture with the modified asphalt as a binder. The asphalt mixture includes the asphalt binder of the first aspect of the disclosure and aggregate.

According to an embodiment, the mixture is a high-modulus asphalt mixture with an asphalt-aggregate ratio of 5% to 8%.

According to another embodiment, the mixture is a guss-asphalt mixture with an asphalt-aggregate ratio of 8% to 15%.

The disclosure further provides a preparation method for the modified asphalt binder of the first aspect of the disclosure. The method includes the following operations.

A natural asphalt is crushed to 300-1000 mesh and the natural asphalt is added to a molten petroleum asphalt to form an asphalt blend.

The asphalt blend is ground when a temperature of the asphalt blend raises to 160° C.-180° C. to obtain the modified asphalt binder.

According to an embodiment, the grinding is performed by a ball mill.

According to an embodiment, a temperature of the molten petroleum asphalt is 130° C.-140° C.

According to an embodiment, the asphalt blend is ground when the temperature of the asphalt blend rises to 170° C.-180° C.

Compared with some implementations in which a natural asphalt mother liquor is prepared in advance, the method of the disclosure is simpler and only needs one step of mixing and one step of grinding. In addition, grinding is performed at the elevated temperature and an amount of the petroleum asphalt is increased in the disclosure, which is more conducive to grinding, thereby obtaining a favorable average particle size and the negative skewed distribution of the particle sizes, further obtaining a more stable asphalt binder and avoiding the use of any additive.

In the disclosure, the modified asphalt obtained by using natural asphalt as a modifier can solve the high-temperature stability problem of the asphalt mixture with a large asphalt-aggregate ratio. Moreover, the natural asphalt has low content of light components, good aging resistance, low cost and no risk of polymer degradation. In addition, the selection of the natural asphalt is not limited to the expensive Trinidad lake asphalt, and a rock asphalt whose price is only 20-30% of Trinidad lake asphalt can also be used, which greatly reduces the cost.

A clear and complete description of the technical solution of the disclosure will be given below in conjunction with examples of the disclosure. It is apparent that the described embodiments are only part of and not all of the embodiments of the disclosure. Based on the embodiments in the disclosure, any other embodiment obtained by those skilled in the art without creative work falls within the protection scope of the disclosure.

Preparation of Asphalt Binders of the Disclosure

### Example 1

70 kg of Buton rock asphalt (with an ash content of about 49%) was crushed to about 300 mesh, and then added at normal temperature into 30 kg of SK-70 asphalt which had been heated to 160° C. to form a blend. The blend was then heated up to 175° C. and then ground by a ball mill at the temperature.

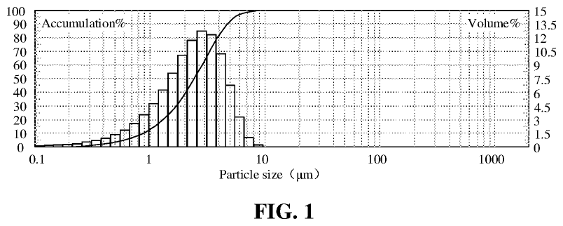

In the obtained asphalt binder, the volume percentage of trichloroethylene-insoluble-substances with particle size of 6 microns or more was 4.5%, the average particle size was 2.6 μm (referring to the particle size distribution diagram shown in FIG. 1), and the penetration degree was in a range of 10-25 dmm.

### Example 2

30 kg of Iranian rock asphalt (with an ash content of about 9%) was crushed to about 300 mesh, and then added at normal temperature into 70 kg of SK-70 asphalt which had been heated to 160° C. to form a blend. The blend was then heated up to 175° C. and then ground by a ball mill at the temperature.

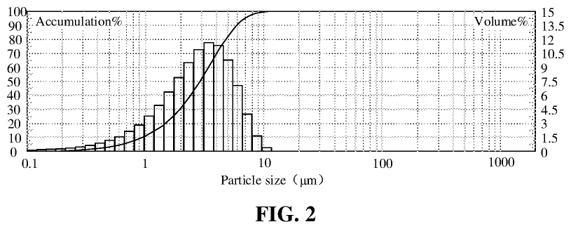

In the obtained asphalt binder, the volume percentage of trichloroethylene-insoluble-substances with particle size of 6 microns or more was 10%, the average particle size was 3.2 μm (referring to the particle size distribution diagram shown in FIG. 2), and the penetration was in a range of 10-25 dmm.

### Example 3

60 kg of Trinidad lake asphalt (with an ash content of about 35%) was crushed to about 300 mesh, and then added at normal temperature into 40 kg of SK-70 asphalt which had been heated to 160° C. to form a blend. The blend was then heated up to 175° C. and then ground by a mill at the temperature.

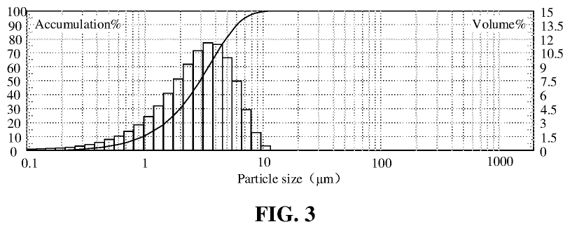

In the obtained asphalt binder, the volume percentage of trichloroethylene-insoluble-substance with particle size of 6 microns or more was 10%, the average particle size was 3.3 μm (referring to the particle size distribution diagram shown in FIG. 3), and the penetration degree was in a range of 10-25 dmm.

### Comparative Example 1

40 kg of Buton rock asphalt (with an ash content of about 49%) was crushed to about 300 mesh, and then added at normal temperature into and mixed with 60 kg of SK-asphalt which had been heated to 160° C. to form a blend. The blend was ground by a ball mill at the temperature. After grinding, 0.5 kg of silane coupling agent and 3 kg of SBS (4303 of Yanshan Petrochemical Company) were added into the blend. The blend was sheared, and then 0.2 kg of sulfur was added into the blend. The blend was developed for 3 hours, and then 0.2 kg of sasobit (SasolWax, Germany) was added into the blend. The blend was stirred for half an hour to obtain the asphalt binder with the penetration degree range of 10-25 dmm.

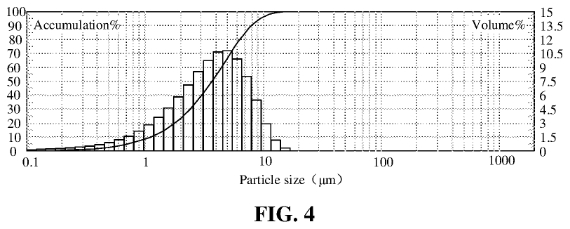

After testing, in the asphalt binder prepared in Comparative Example 1, a volume percentage of trichloroethylene-insoluble-substances with particle size of 6 microns or more was 24%, and the average particle size was 4.2 μm (referring to the particle size distribution diagram shown in FIG. 4).

### Comparative Example 2

50 kg of Buton rock asphalt (with an ash content of about 49%) was crushed to 300 mesh, and then added at normal temperature into and mixed with 50 kg of SK-70 asphalt which had been heated to 160° C. to form a blend. The blend was then ground directly according to a same grinding process as Example 2, so as to obtain the asphalt binder of Comparative Example 2.

Results:

The asphalt binders prepared in the above Examples and Comparative Examples were tested as follows.

Average particle size of insoluble-substances, insoluble-substances D90, insoluble-substances D10, volume percentage of trichloroethylene-insoluble-substances with particle size of 6 microns or more were measured by a winner 2000E laser particle size analyzer produced by Jinan Winner Particle Instrument Co., Ltd.

Other indexes, such as penetration degree and softening point, were measured according to “Standard Test Methods of Bitumen and Bituminous Mixtures for Highway Engineering” (JTG E20-2011).

The results are shown in Table 1:

TABLE 1

| | | | | | Comparative | Comparative | Test |
|---|---|---|---|---|---|---|---|
| Test item | Unit | Example 1 | Example 2 | Example 3 | Example 1 | Example 2 | method |
| Average particle | μm | 2.6 | 3.2 | 3.3 | 4.2 | 18.6 | Laser |
| size of insoluble- | | | | | | | particle |
| substances | | | | | | | size |
| Insoluble-substances | μm | 4.7 | 6.0 | 6.2 | 8.1 | 47.3 | analyzer |
| D₉₀ | | | | | | | |
| Insoluble-substances | μm | 0.9 | 0.9 | 1.0 | 1.1 | 1.8 | |
| D₁₀ | | | | | | | |
| volume percentage | % | 4.5% | 10% | 10% | 24% | — | |
| of trichloroethylene- | | | | | | | |
| insoluble-substances | | | | | | | |
| with particle size | | | | | | | |
| of 6 microns or more | | | | | | | |
| Penetration Degree | 0.1 mm | 18 | 21 | 24 | 20 | 27 | T0604 |
| (25° C., 100 g, 5 s) | | | | | | | |
| Softening point | ° C. | 68 | 70 | 66 | 75 | 65 | T0606 |
| Flash point | ° C. | 370 | 399 | 346 | 271 | 377 | T0611 |
| Viscosity (175° C.) | Pa · s | 1.23 | 1.37 | 0.99 | 1.02 | Unable to | T0625 |
| | | | | | | measure | |
| Storage stability, | ° C. | 2 | 1.8 | 2.3 | 0.5 | Severely | T0661 |
| softening point | | | | | | segregation | |
| difference after | | | | | | | |
| 48 h segregation | | | | | | | |
| Residues after TFOT or RTFOT | | | | | | | T0609 |
| Quality change | % | −0.2 | 0.2 | −0.3 | 0.2 | 0.1 | T0610 |
| Residual | % | 92 | 81 | 89 | 88 | 83 | T0604 |
| penetration | | | | | | | |
| ratio (25° C.) | | | | | | | |

From Examples 1 to 3, it is clear that, when no polymer modifier is added, a content of the natural asphalt needs to be increased to reduce the penetration degree of the binder, which can increase the amount of the natural asphalt used, and further reduce the cost. There is no ductility requirement for hard asphalt. Because no polymer modifier is used, the flash point of the asphalt binder is improved and the safety is better. Meanwhile, although the softening point of the asphalt binder is reduced, it meets application requirements within technical requirements.

From Comparative Example 2, it is clear that without a heating process before grinding, the grinding effect is poor, the particle sizes are large and the distribution is uneven, which leads to the viscosity data being undetectable (the particle sizes are large and the distribution is wide, which lead to unstable viscosity data, so that it is difficult to obtain effective data.) and the storage stability being poor. The heating process is very important for reducing the viscosity and improving the grinding effect.

Preparation of Guss Asphalt Mixtures

0-3 mm, 3-5 mm, 5-10 mm aggregate and mineral powder were screened, and gradation curves were designed according to the design gradation requirements, as shown in Table 2 below.

TABLE 2

| | Composition of Mineral aggregate | | | | | | |
|---|---|---|---|---|---|---|---|
| | Passing percentage (%) of mineral aggregates through the sieve holes | | | | | | |
| Sizes of | (1) | (2) | (3) | (4) | | GA-10 | |
| sieve holes | 5-10 | 3-5 | 0-3 | Mineral powder | synthetic | Lower | Upper |
| (mm) | 20 | 26 | 32 | 22 | gradation | limit | limit |
| 13.2 | 99.4 | 100.0 | 100.0 | 100.0 | 99.9 | 100.0 | 100.0 |
| 9.5 | 92.5 | 99.8 | 99.3 | 100.0 | 98.2 | 80.0 | 100.0 |
| 4.75 | 10.6 | 65.7 | 98.8 | 100.0 | 72.8 | 63.0 | 80.0 |
| 2.36 | 2.7 | 8.9 | 77.6 | 100.0 | 49.7 | 48.0 | 63.0 |
| 1.18 | 2.5 | 7.0 | 59.9 | 100.0 | 43.5 | 38.0 | 52.0 |
| 0.6 | 2.4 | 6.3 | 42.6 | 100.0 | 37.8 | 32.0 | 46.0 |
| 0.3 | 2.3 | 5.8 | 29.2 | 97.2 | 32.7 | 27.0 | 40.0 |
| 0.15 | 2.1 | 5.1 | 21.8 | 89.8 | 28.5 | 24.0 | 36.0 |
| 0.075 | 1.9 | 4.4 | 16.1 | 75.7 | 23.3 | 20.0 | 30.0 |

Aggregate quality should meet the requirements of the current industry standard “Technical Specification for Construction of Highway Asphalt Pavements” (JTG F40). A process for preparing the above mixtures was as follows.

The aggregate was heated to 280° C., and then dry-mixed for 40 seconds in a mixing pot (the temperature was set at 250° C.). An asphalt binder which has been heated to 185° C. was added into the mixing pot at a certain asphalt-aggregate ratio, and then stirred for 90 seconds. The mineral powder was then poured into the mixing pot, and then stirred for 40 min to obtain the mixture.

### Example 4

Aggregates were prepared according to the above gradation requirements, and the asphalt mixture was prepared with the asphalt of Example 1 as a binder and with the asphalt-aggregate ratio of 11.7%.

### Example 5

Aggregates were prepared according to the above gradation requirements, and the asphalt mixture was prepared with the asphalt of Example 2 as a binder and with the asphalt-aggregate ratio of 11.7%.

### Comparative Example 3

Aggregates were prepared according to the above gradation requirements, and the asphalt mixture was prepared with the asphalt of Comparative Example 1 as a binder and with the asphalt-aggregate ratio of 11.7%.

The Lueer fluidity (240° C., s), penetration (60° C., mm), penetration increment (mm), dynamic stability (times/mm) and low-temperature bending failure strain (−10° C., με) of Examples 4, 5 and Comparative Example 3 were measured.

The Lueer fluidity, penetration and penetration increment were measured according to “Specifications for Design and Construction of Pavement on Highway Steel Deck Bridge” (JTG/T3364-02-2019). The dynamic stability and low-temperature bending failure strain were measured according to “Standard Test Methods of Bitumen and Bituminous Mixtures for Highway Engineering” (JTG E20-2011).

Test results of the mixtures are shown in Table 3 below:

TABLE 3

| | | | Test results | | | |
|---|---|---|---|---|---|---|
| | | Technical | | | Comparative | Test |
| Test item | | requirements | Example 4 | Example 5 | Example 3 | method |
| 1 | Lueer fluidity | ≤20 | 17.8 | 19 | 16.0 | Lueer fluidity |
| | (240° C., s) | | | | | test |
| 2 | Penetration | 1.0-4.0 | 2.45 | 1.77 | 2.94 | Penetration and |
| | (60° C., mm) | | | | | Penetration |
| 3 | Penetration | <0.4 | 0.15 | 0.1 | 0.25 | incremental test |
| | increment (mm) | | | | | |
| 4 | Dynamic stability | ≥1200 | 1245 | 1598 | 964 | T0719 |
| | (times/mm) | | | | | |
| 5 | low-temperature | ≥3000 | 3200 | 2800 | 3785 | T0715 |
| | bending failure | | | | | |
| | strain (−10° C., | | | | | |
| | με) | | | | | |

The size of trabecula in the low-temperature bending failure strain test was 250 mm×30 mm×35 mm.

A low-temperature bending failure strain of the asphalt mixture without polymer modifier was not as good as that of the asphalt mixture with polymer modifier, but it had already met the technical requirements for winter warm regions and summer hot regions. The asphalt mixture without polymer modifier is more suitable for summer hot regions. The asphalt mixtures without polymer modifier have better dynamic stability and excellent rutting resistance.

The technical requirements in the above table refer to the technical requirements for winter cold regions, winter warm regions and summer hot regions in “Specifications for Design and Construction of Pavement on Highway Steel Deck Bridge” (JTG/T3364-02-2019).

Preparation of High-Modulus Asphalt Mixtures

0-3 mm, 3-5 mm, 5-10 mm aggregate and mineral powder were screened, and gradation curves are designed according to the design gradation requirements, as shown in Table 4 below.

TABLE 4

| | Passing percentage (%) of mineral aggregates through the sieve holes (mm) | | | | | | | | | | | |
|---|---|---|---|---|---|---|---|---|---|---|---|---|
| Type | 26.5 | 19 | 16 | 13.2 | 9.5 | 4.75 | 2.36 | 1.18 | 0.6 | 0.3 | 0.15 | 0.075 |
| Production | 100 | 99.4 | 91.1 | 78.9 | 64.5 | 50 | 37.3 | 23.5 | 14.1 | 10.5 | 7.5 | 5.2 |
| ratio | | | | | | | | | | | | |
| Gradation | — | 100 | 90-100 | — | 66-84 | 42-64 | 27-42 | — | — | — | — | 5.5-8.0 |
| rang | | | | | | | | | | | | |

The aggregate was heated to 190° C., and then dry-mixed for 40 seconds in a mixing pot (the temperature was set at 185° C.). An asphalt which has been heated to 185° C. was added into the mixing pot at a certain asphalt-aggregate ratio, and then stirred for 90 seconds. The mineral powder was then poured into the mixing pot, and then stirred for 90 seconds to obtain the mixture.

### Example 6

Aggregates were prepared according to the above gradation requirements, and the asphalt mixture was prepared with the asphalt of Example 1 as a binder and the asphalt-aggregate ratio of 5.7%.

### Comparative Example 4

Aggregates were prepared according to the above gradation requirements, and the asphalt mixture was prepared with the asphalt of Comparative Example 1 as a binder and the asphalt-aggregate ratio of 5.7%.

Complex modulus (15° C., 10 Hz) and fatigue life (10° C., 25 Hz, 130με) of Example 6 and Comparative Example 4 were measured respectively according to EN 12697-26 and EN 12697-24 in “EN12697 Series Standards” of European bituminous mixtures test methods.

The indexes of the tested mixtures are shown in Table 5 below.

TABLE 5

| | | | | Test result | | |
|---|---|---|---|---|---|---|
| | | | technical | | Comparative | Test |
| Number | Test item | Unit | requirements | Example 6 | Example 4 | method |
| 1 | Dynamic stability | Times/mm | ≥5000 | 8770 | 5350 | T0719 |
| 2 | low-temperature | με | ≥2000 | 2450 | 3780 | T0715 |
| | bending failure | | | | | |
| | strain (−10° C.) | | | | | |
| 3 | Complex modulus | MPa | ≥14000 | 18400 | 17800 | EN12697-26 |
| 4 | Fatigue life | ten | ≥100 | 127 | 142 | EN12697-24 |
| | (10° C., 25 Hz, | thousand | | | | |
| | 130 [symbol] | times | | | | |

[symbol]

indicates data missing or illegible when filed

Compared with the formula with polymer modifier, the low-temperature bending failure strain of the formula without modifier is reduced, but is enough to meet the application requirements in winter warm regions (according to “Technical Specification for Construction of Highway Asphalt Pavements” (JTG F40), the low-temperature bending failure strain in winter warm regions should not be less than 2000με). The modulus and fatigue life meet the technical requirements of a high-modulus asphalt mixture. On the basis of meeting the performance requirements, the cost can be reduced by 20-30% without using polymer modifier.

The description above is only preferred embodiments of the disclosure, and is not intended to limit the protection scope of the disclosure. Any equivalent structural transformation made by using the contents of the specification and drawings of the disclosure, or direct/indirect application in other related technical fields, within the conception of the disclosure, falls within the protection scope of the disclosure.

1. A modified asphalt binder, comprising a natural asphalt and a petroleum asphalt with a weight ratio of (30-70):(70-30), wherein an ash content in the natural asphalt is up to 60% base on a weight of the natural asphalt, and a volume percentage of a trichloroethylene-insoluble-substances with a particle size of 6 microns or more in the modified asphalt binder is less than 10%.

2. The modified asphalt binder of claim 1, comprising the natural asphalt and the petroleum asphalt with a weight ratio of (35-60):(65-40).

3. The modified asphalt binder of claim 1, wherein the ash content in the natural asphalt is up to 50% base on the weight of the natural asphalt, and the volume percentage of the trichloroethylene-insoluble-substances with particle size of 6 microns or more in the modified asphalt binder is less than 5%.

4. The modified asphalt binder of claim 1, wherein the natural asphalt is selected from one or more of Iranian rock asphalt, Buton rock asphalt, Trinidad lake asphalt or China Qingchuan rock asphalt.

5. The modified asphalt binder of claim 1, wherein the petroleum asphalt is selected from one or more of petroleum asphalt 50 #, petroleum asphalt 70 #, petroleum asphalt 90 # or petroleum asphalt 110 #.

6. The modified asphalt binder of claim 1, wherein a penetration degree of the modified asphalt binder is 10-25 dmm.

7. The modified asphalt binder of claim 1, wherein the trichloroethylene-insoluble-substances in the modified asphalt binder have an average particle size of 2-6 μm, preferably 3-4 μm.

8. The modified asphalt binder of claim 1, wherein the modified asphalt binder consists of the natural asphalt and the petroleum asphalt.

9. A guss-asphalt mixture, comprising the modified asphalt binder of claim 1 and aggregate, wherein an asphalt-aggregate ratio of the guss-asphalt mixture is 8%-15%.

10. A high-modulus asphalt mixture, comprising the modified asphalt binder of claim 1 and aggregate, wherein an asphalt-aggregate ratio of the high-modulus asphalt mixture is 5%-8%.

11. A method for preparing the modified asphalt binder of claim 1, comprising:
crushing a natural asphalt to 300-1000 mesh and adding the natural asphalt to a molten petroleum asphalt to form an asphalt blend; and
when a temperature of the asphalt blend rises to 160° C. to 180° C., grinding the asphalt blend to obtain the modified asphalt binder.

12. The method of claim 11, wherein the grinding is performed by a ball mill.

13. The method of claim 11, wherein a temperature of the molten petroleum asphalt is 130° C.-140° C.

14. The method of claim 11, wherein when the temperature of the asphalt blend rises to 170° C. to 180° C., the asphalt blend is ground.
